(19) United States
(12) Patent Application Publication
(10) Pub. No.: US 2006/0015479 A1
(43) Pub. Date: Jan. 19, 2006

(54) Contextual navigation and action stacking

(76) Inventors: Eric Wood, Menlo Oaks, CA (US); Joerg Beringer, Frankfurt (DE)

Correspondence Address: KENNETH F. KOZIK, ESQ.;HOLLAND & KNIGHT LLP, 10 ST. JAMES AVENUE, BOSTON, MA, 02116, US

(21) Appl. No.: 11/184,736

(22) Filed: Jul. 19, 2005

(30) Foreign Application Priority Data
Jul. 19, 2004 (EP) EP 04016993.0

(51) Int. Cl. G06F 17/30

(52) U.S. Cl. 707/2

(57) ABSTRACT

Methods and apparatus, including computer program products, for contextual navigation and action stacking. A method includes, in a computer system having a context repository in which at least two context templates are stored, each of the context templates representing a meta-model of a business situation, and an action repository in which at least two actions are stored having respective action definitions, instantiating a context in response to the business situation based on a context template stored in the context repository, the instantiated context representing a model of the business situation, associating at least one action with the instantiated context, generating a user interface (UI) based on an interface template, the UI enabling at least one action to a user based on the instantiated context, the at least one action adopting the instantiated context, in response to a user's selection of one of the at least one action, enabling the user with a plurality of sub-actions the user can perform before completing the one action, and adding the plurality of sub-actions to the instantiated context, the sub-actions adopting the instantiated context.

### CROSS REFERENCE TO RELATED APPLICATIONS

This application claims the benefit from EP 04016993.0, filed on Jul. 19, 2004, the entire contents of which is incorporated herein by reference.

### BACKGROUND

The present invention relates to data processing by digital computer, and more particularly to contextual navigation and action stacking.

Business applications running on programmable devices, such as computers, aid users performing their activities within an enterprise. For example, a business application may guide a user through the steps of a certain business process in a certain order, e.g., hiring a new employee. Business applications can be implemented using multiple services and can provide the user with one or more services at a graphical user interface (GUT), such as filling. in and submitting a form to a database (e.g., with the new employee's name, address, and so forth), and ordering items (e.g., a workplace for the new employee, and so forth).

Users can utilize business applications to complete daily tasks, including numerous sub-tasks, to reach a desired goal. This can necessitate features and functions spanning across an application's solution space, or features and functions from a second application, which may not be directly associated with the function last used. This can result in a situation where users are forced to create a mental model of the application so that they can plan the correct order in which to complete sub-tasks, and have an intimate understanding where and how features required for the next sub-task can be accessed. Furthermore, a user's goal may necessitate functions that span across different applications.

For example, a GOMS (Goal, Operations, Methods, Selection) Model can be used to explain how a user breaks down high level goals into sub-goals, and finally into actual actions or steps. “Goals” represent the goals that a user is trying to accomplish, usually specified in a hierarchical manner. “Operators” are a set of atomic-level operations with which a user composes a solution to a goal. “Methods” represent sequences of operators, grouped together to accomplish a single goal. Selection Rules are used to decide which method to use for solving a goal when several methods are applicable.

It is desirable to allow users to complete a task that can span across many applications without forcing the user to have to create a mental model of the application or applications.

### SUMMARY

The present invention provides methods and apparatus, including computer program products, for contextual navigation and action stacking.

In general, in one aspect, the invention features a computer-implemented method including, in a computer system having a context repository in which at least two context templates can be stored, each of the context templates representing a meta-model of a business situation, and an action repository in which at least two actions can be stored having respective action definitions, instantiating a context in response to the business situation based on a context template stored in the context repository, the instantiated context representing a model of the business situation, associating at least one action with the instantiated context, generating a user interface (UI) based on an interface template, the UI enabling at least one action to a user based on the instantiated context, the at least one action adopting the instantiated context, in response to a user's selection of one of the at least one action, enabling the user with a plurality of sub-actions the user can perform before completing the one action, and adding the plurality of sub-actions to the instantiated context, the sub-actions adopting the instantiated context.

In embodiments, the method can include filtering the instantiated context associated with the one or more action so the plurality of sub-actions added adopt the filtered instantiated context and/or enabling a control in the UI to govern a completion of at least one of the action and sub-action.

The actions and sub-actions can be portable user interface (UI) services. The actions can be related goals and the sub-actions can be related sub-tasks. The sub-tasks can be contextual actions that the user can perform before completing a goal. The instantiated context can include context data, the context data being passed to the sub-actions. The generated UI can enable stacking of the sub-actions on the selected action. The method can include a user interface navigation framework (UINF) that maintains context through the stack of sub-actions. The method can include incrementally adding additional context with each sub-task. A sub-action can be provided as a possible action that the user should complete before successfully completing an action.

The invention can be implemented to realize one or more of the following advantages.

The method enables designers and developers of software to provide everything a user needs in order to complete a goal from a user interface of a particular sub-task. Steps are referred to as actions and represent a single task, and have a single set of controls that govern an outcome of the action. The controls are referred to as action level controls.

The method provides links to end goals and not to intermediate steps. If intermediate steps are needed, the user can complete the one step and their goal has been obtained. If prerequisites are needed in order to complete an end goal, these intermediate steps can be done from within a context of an original goal.

One implementation of the invention provides all of the above advantages.

Other features and advantages of the invention are apparent from the following description, and from the claims.

### BRIEF DESCRIPTION OF THE DRAWINGS

FIG. 1 is a diagram illustrating different goals presented to a user in a work center;

FIG. 2 is a diagram illustrating actions a user may want to do before completing an end goal;

FIG. 3 is a diagram illustrating a stack of actions;

FIG. 4 is a diagram of a stack of actions;

FIG. 5 is a block diagram of a computer system suitable for implementing a business application;

FIG. 6 is an example of an action template context template, an action definition and a context instance;

FIG. 7 is a first example of a context template linked to actions definitions;

FIG. 8 is a second example of a context template linked to actions definitions;

FIG. 9 is a third example of a context template linked to actions definitions and to a user interface template;

FIG. 10 is a block diagram of an exemplary computer system provided with a business application;

FIG. 11 is a block diagram of a Graphical User Interface (GUI) suitable for in the example of FIG. 9;

FIG. 12 is a diagram illustrating the concept of an action;

FIG. 13 is a diagram illustrating an action gallery and its respective user interfaces in a work context;

FIG. 14 is an implementation of an action specific user interface, and

FIG. 15 is a block diagram of an exemplary computer network provided with a business application.

Like reference numbers and designations in the various drawings indicate like

### DETAILED DESCRIPTION

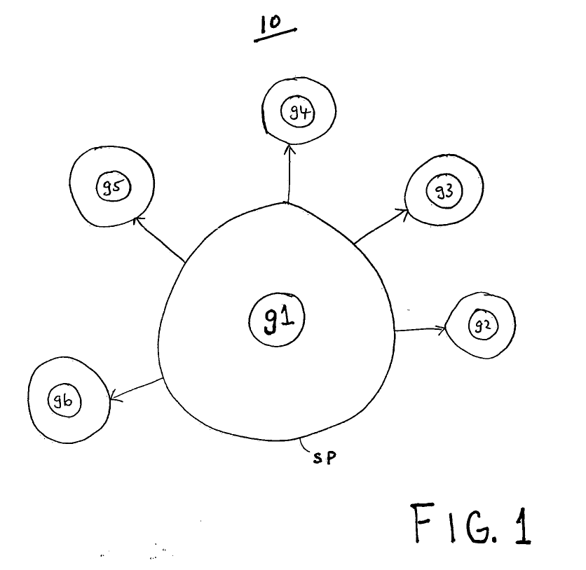

FIG. 1 shows an example schematic drawing illustrating different end goals presented to a user in a work center 10.

The work center 10 is a place corresponding to a business situation. The work center 10 has a work context, which is the context instantiated in accordance with the business situation. The work center 10 is the starting point (SP) for the user, and is provided to the user in a user interface (UI). The UI is generated by a user interface generator in accordance with a user interface template. At the SP, actions are associated with the instantiated context. The actions g1, g2, g3, g4, g5 and g6 are presented to the user in the UI. The actions can represent a plurality of end goals g1, g2, g3, g4, g5 and g6. The user may wish to complete one or more of the goals. In a particular example, a multi-step contextual action with nested sub-goals is supported within a given context whereby additional context is incrementally added with each step. This is achieved by implementing a generic context/action based meta data model, and a user interface navigation framework (UINF) that stacks actions on top of each other and automatically maintains context along the chain of actions.

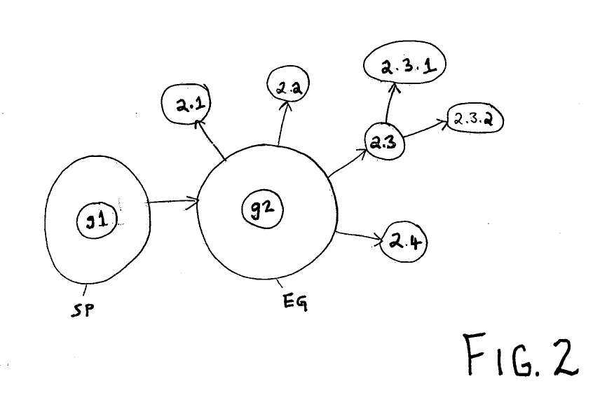

FIG. 2 is a schematic drawing illustrating actions a user may want to do before completing an end goal (EG). In the example shown in FIG. 2, the user has selected a goal g2. On selecting an end goal (action), sub-actions are made available to the user in accordance with an instantiated context. The sub-actions may also be referred to as sub-tasks. The sub-actions 2.1, 2.2, 2.3, 2.4 are contextual actions. In particular, they are actions a user may want to complete before completing the end goal g2. Certain actions 2.3 may include further sub-actions 2.3.1, 2.3.2 that the user may wish to complete. The plurality of actions and sub-actions are portable user interface services. An action may complete a single goal. Contextual information, for example, which business object (BO) or procedure a particular sub-action is called from, is passed to the sub-action. In one example, the instantiated context includes context data that is passed to the sub-actions.

Adding actions to an open context is called “action stacking.” An action stack is adding an action on top of the current instantiated context. Actions filter their given context so that additional actions stacked above adopt the filtered context.

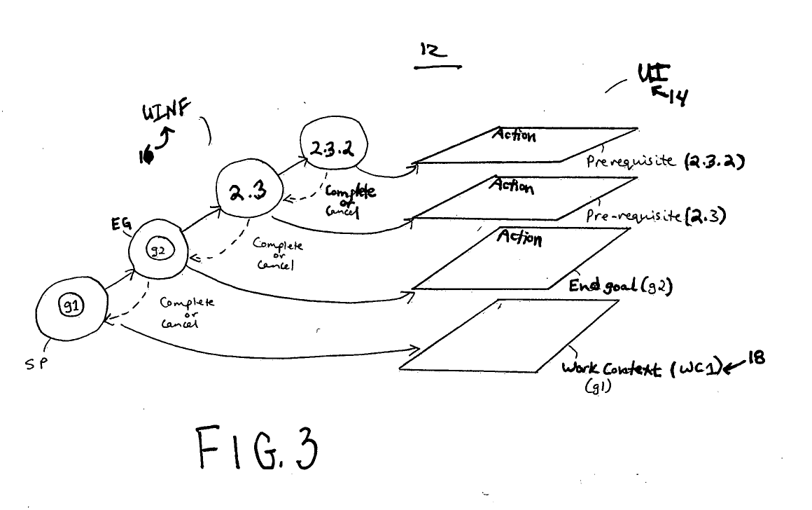

FIG. 3 shows a schematic drawing illustrating a stack of actions 12. FIG. 3 further shows a user interface (UI) 14 for providing the stack of actions 12 to the user. FIG. 3 further shows a user interface navigation framework (UINF) 16 for automatically maintaining context through the stack of actions 12.

Actions 2, 2.3, 2.3.1, 2.3.2 may be services built for work center 1 (WCI) 18. Alternatively, there may be services built for another work center, for example, the work center associated with a goal, in the same application. The actions 2, 2.3, 2.3.1, 2.3.2 may be services built for a separate application. In this case, the service may conform to a standard model of context feeding metadata and contextual actions. Actions 2, 2.3, 2.3.1, 2.3.2 are stacked because the source of their instantiation is kept open. In order to complete end goal g2, the user may decide which of the sub-actions he desires to complete. In the example shown in FIG. 3, the user has determined, in completing goal g2, that it is desirable to complete pre-requisite 2.3. While completing prerequisite 2.3, the user has also determined that it is desirable to complete pre-requisite 2.3.2. In this way, the user can determine and create their own work flow. The end goal g2 and the desired sub-actions are then stacked on the work center 18. The end goal g2 and the sub-actions maintain the instantiated context of the work center 18. Having determined which of the sub-actions 2.3, 2.3.2 the user wishes to complete, the user then completes or cancels the entire action stack above the WC1 18. In order to do so, action level controls are provided. In particular, via the user interface 14, a control to govern a completion of at least one of the actions and sub-actions is provided. Action level controls may also be referred to as page level buttons.

Actions may be stacked by clicking on action buttons, for example, links. An action may have a name that starts with a verb, for example, “Create,” “Edit,” and so forth. As described above, actions may be a simple action, for example a form. Alternatively, they may be guided actions, for example, a wizard. Guided actions may need to be saved or cancelled. Further, guided actions may include management screens that may be dismissed. As mentioned above, actions adapt the context of the entity they are stacked on. For example, the actions shown in FIG. 3 adopt the context of the WC1 18. In particular, an action is a generic modifier that can be applied to any appropriate context without the need to design and build custom user interfaces for the same action in different contexts. Actions are inherently transaction centric.

Action stacking provides a way in which a user can create interactions in an ad-hoc manner depending on their needs in a given context, without needing to script a linear activity.

These types of interactions are goal-driven because they are generated “on the fly” by the user selecting controls that identify the actions, for example, using verbs, such as “Create,” “Edit,” and so forth. In this way, actions and action stacking may be utilized to provide a flexible framework for reusable transactions and user generated interactions for a given context. Further, by providing a methodology of providing links to end goals, not to intermediate steps, as in conventional applications, if intermediate steps are not needed, the user can simply complete the simple step and their goal has been obtained. If prerequisites are needed, for example, as shown in FIG. 3, in order to complete the end goal g2, then these intermediate, or sub-tasks, can be done from within the context of the original end goal.

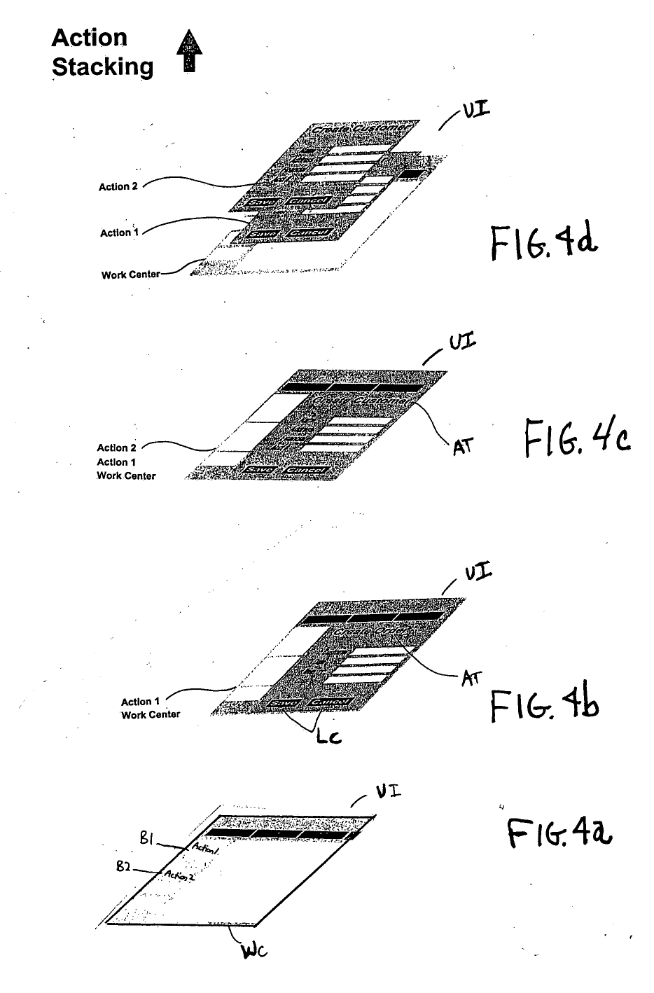

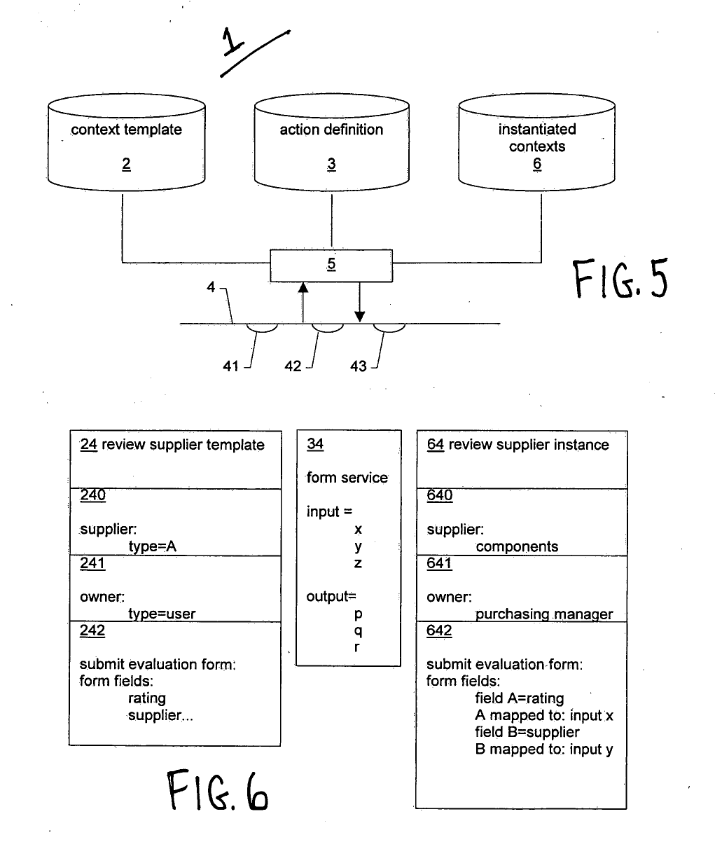

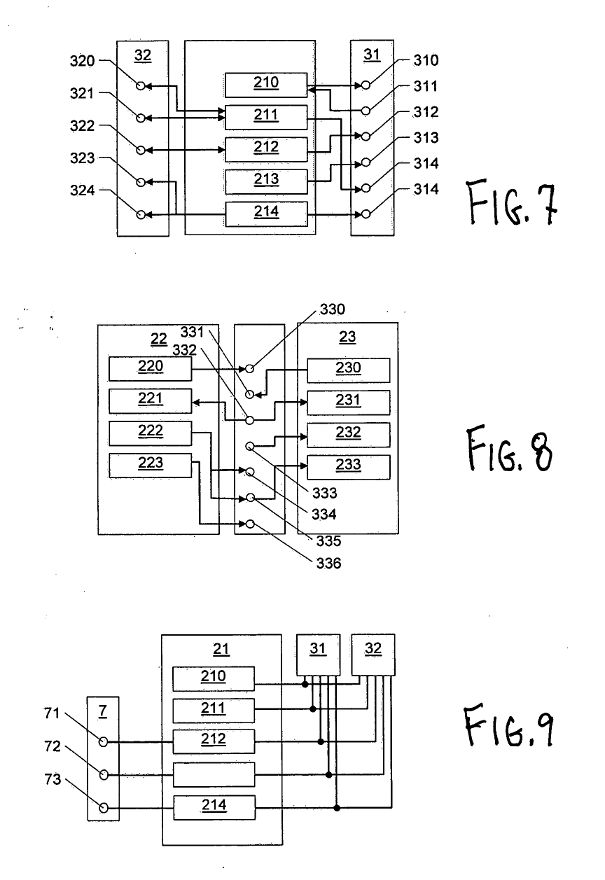

FIGS. 4a, 4b, 4c and 4d show further illustrations of a stack of actions. FIG. 4a shows an example of a work center having an instantiated context. The work center is associated with a business situation. Associated with the context in the work center are actions, which may be goals. These actions are displayed to a user in the UI. When a user clicks on an action, for example, a button B1, B2, corresponding to action 1 and action 2, respectively, the screen refreshes in the same browser window, but the context does not change. A behavioral assumption is made that if a user has focused on a given context, any change they elect to do is applied to the current context. With reference to FIG. 4b, a user has selected a button B1 corresponding to action 1. Action 1 is an action to Create Order. The action includes certain fields in which data may be entered, for example, Customer, Date, Item and Cost. The UI for action 1 may also include action level controls. The controls include a save control and a cancel control. Other controls can be included, such as “complete”. The buttons may also be a text link or an icon. As described above, actions may be denoted by a verb. Action 1 includes the field “Customer”. If the situation warrants, for example, if the customer is new, a further sub-action may be stacked on the first action. In this case, with reference to FIG. 4c, the sub-action (action 2) is Create Customer. The sub-action (action 2) may be stacked on top of the existing action 1. These sub-actions (action 2) also adopt the context of any actions lower in the stack.

With reference to FIG. 4d, although the user cannot see it, in the user interface UI, the lower actions in the stack, that is action 1, is kept open, so that when the user completes the top most action, the lower actions are again revealed to the user with the results of completing the higher action. Thus, once the user has created a customer by entering data in the fields: Name, Address, Financial, Account number, the user interface showing action 2 is removed; once the user has saved the data, the user interface for action 1 is again revealed to the user with the customer data complete.

In FIG. 5, a computer system 1 is shown for implementing the business application described above with reference to FIGS. 1-4. In order to provide an instantiated context, the computer system 1 includes a context template repository 2 and an action repository 3. The computer system 1 further has an interface 4 that is provided with suitable controls 41-43, for implementing a service oriented business application. The interface 4 and the repositories 2,3 are linked to a processor 5.

In the context template repository 2, context definitions, also referred to as context templates, are stored. The context templates provide meta-data about a context and each context template represents a meta-model of a business situation. The context template defines the structure of the context, possible parameters, how the context and services interact in terms of parameters passing, and so forth. The meta-model may define parameters related to a specific work context, such as artifacts used in the work context, actions which can be performed and people involved in the work context or any other suitable parameter.

A context template may, for example, represent an activity-centric meta-model. The context template then provides a meta-model of an activity within an enterprise, such as a role, topic, task, or event in a business situation. Depending on the specific type of activity, certain types of actions and resources may be used in a context and can be pre-configured in the context template. For example, an activity-centric meta-model may define that a user is to be provided with certain information, such as work-lists, work status dashboards, resources, participants, and so forth. The context template may, for example, be a meta-model of collaborative activities in a business. In such case, the context template may, for example, define parameters of a collaborative activity such as the parameters: initiator, participants, actions to be performed, and contain meta-data about these parameters.

For example, the context template may define that the parameter initiator may have listed values only, e.g. of the type “manager”, “delegate”, and so forth.

The context template may represent an object-centric meta-model. The context template then provides a meta-model that is centered around an object in a business situation. For instance, the context template may be a meta-model of a business situation centered around a certain job. The context template may include object related operations as well as views on all facets on the object. Different job roles may be interested in different facets of the same object type.

The context template may represent a process-centric meta-model. The context template then provides a meta-model of a workflow in a business situation. Most actions are executed as predefined process steps. Because of the nature of workflow, selected steps may be owned by different users. The context template may then define, e.g., that a process has an initiator, and types of participants, which steps are to be performed by which types of participants, and so forth. The context template may define that an initiator is of a type with a certain role in an enterprise, that the participants have a certain position within the enterprise, and so forth.

When implementing a business application, a context template can be selected. The context template can then be instantiated, creating a context instance. When the context template is instantiated, an object which has the structure and parameters defined by the context template is created and values are assigned to the parameters. The instantiated context further represents a model of a business situation which conforms to the meta-model represented by the context template.

FIG. 6 schematically illustrates a supplier review context template 24. The supplier review context template 24 represents an activity centric meta-model. In the example of FIG. 6, the activity around which the template 24 is centered is a review of a supplier. The context template 24 provides a meta-model of a review activity, and defines that such a model of a review process has parameters 241,242 of a certain type. In this particular example, a model of the type “supplier review” has a “supplier” parameter 240 of a type A, and an “owner” parameter of type “user”. The example of a context template 24 further defines that a review model uses certain services. In this example, the context template 24 defines an activity model of the type “supplier review” requires submitting an evaluation form with certain fields.

The context template 24 contains a service definition 242 which, inter alia, defines a form with form fields “rating” and “supplier”.

In the action repository 3, one or more action definitions are stored. An action definition contains at least a definition of the inputs and outputs of the action, i.e. the actions definition defines at least the input/output interface of an action. However, the action definition may also contain other information about an action, such as which other actions can be associated with the action and what the functionality of the action or other suitable information.

In FIG. 6, an action definition 34 defines inputs x,y, and z and outputs p,q and r of a form processing service. When implementing a business application which assists users in performing a review activity, the context template 24 is selected and instantiated, resulting in a supplier review context instance 64. The supplier review context instance 64 has the parameters and structure defined by the context template 24, and values are assigned to the parameters. The supplier review context instance 64 represents a model of a business situation which conforms with the meta-model represented by the context template 24.

In this example, e.g. the supplier review context instance 64 provides a model how a supplier review process is performed. For example, the supplier review context instance 64 models that in a business environment, the review process is owned by a purchasing manager, and that a supplier of components is reviewed. The supplier review context instance 64 further models that in the review process, an evaluation form is submitted of which field A represents the supplier rating and field B represents an identification of the supplier.

When implementing the business application, one or more action definitions may be selected from the action repository 3 using the interface. The selected action definition is associated with the instantiated context. At least one parameter of the instantiated context is mapped with one or more input or output parameters of the selected action definition. At run time of the business application, an action in accordance with the action definition is called from the context. The action then executes services, i.e. performs procedures or functions hosted on a computer server, and may return status information and result parameters to the context, generate a new context or perform other suitable functions.

In FIG. 6, during implementation of the business application, the parameters of the evaluation form of the instance 64 are mapped to inputs of the form service definition 34.

In this example, field A is mapped to input x, and field B is mapped to input y. The mapping is stored in the supplier review context instance 64, as shown in form field 642 of the supplier review context instance 64.

FIG. 7 illustrates a mapping of parameters of an instantiated context to input or output parameters of an action definition. An action definition may define that a certain service has inputs 311-315 and has an output 310 as for example shown in FIG. 7. The parameters 210-214 of the instantiated context may then be mapped to the inputs 311-315 and the output 310. As shown in the example, parameters 210-214 are each mapped to a different one of inputs 311-315, and the output 310 is mapped to parameter 210. For another action definition 32, the parameters may be mapped differently.

Thus, in the example of FIG. 7, in case the implemented business application is run on a suitable apparatus, a service in accordance with the action definition 31 will receive input data from parameters 210-214 via inputs 311-315, and output data to the instantiated context 21 via output 310. This output data will be received by a parameter of a context corresponding to parameter 210. The output of the service corresponding to the action definition 32 is thus provided to the context 21, which is modified thereby. The other action definition 32 can then use the modified context 21 to obtain input and/or to output data. In this example, the context 21 thus operates as a data exchange fabric for two or more actions. Accordingly, the necessity to match the input/output interfaces of the different services to each other is obviated and data can be transferred in a simple manner from one service to another service.

In the example of FIG. 7, the inputs and/or outputs of the action definitions 31,32 are mapped to parameters of one context 21. However, it is also possible that when implementing a business application, inputs and/or outputs of an action definition are mapped to two or more contexts, e.g. as shown, for example, in FIG. 8. In FIG. 8 instantiated contexts 22,23. At run time, one of the contexts 22,23 can be selected and the selected context 22 can interact with actions according to the action definitions associated with the selected context.

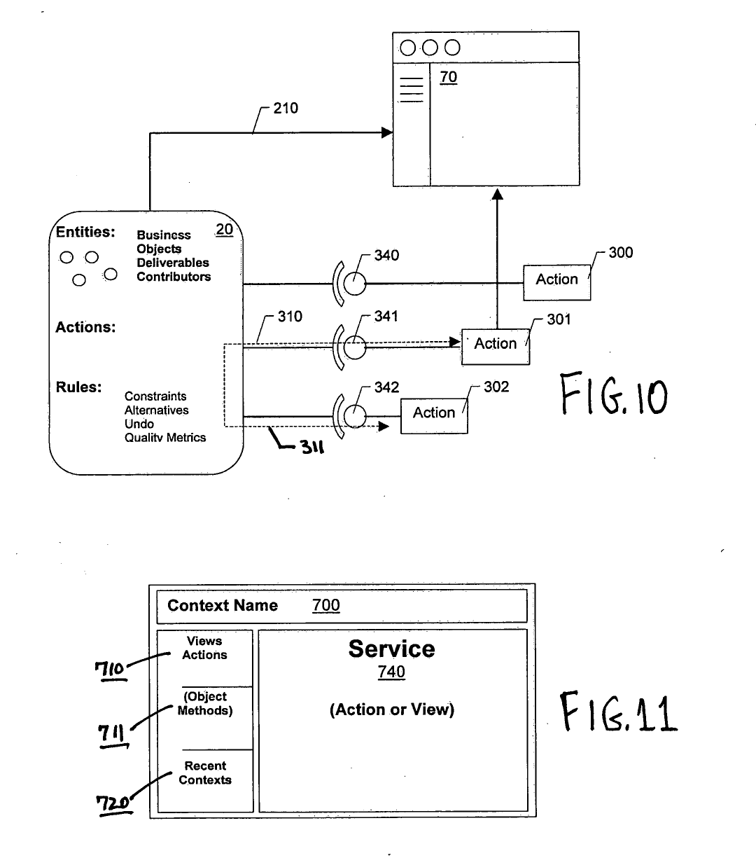

As shown in FIG. 9, one or more parameters of the instantiated context can be coupled to a user-interface definition 7. In FIG. 9, the context 21 and the actions definitions 31,32 shown in FIG. 7 are shown, and the parameters 212-214 are coupled to respective inputs 71-73 of a user-interface (UI) definition.

The user-interface definition defines a UI corresponding to the definition 7. The UI definition 7 may define a template for a graphical user interface (GUI), such as which windows will be present in the GUI, what type of information has to be displayed in the windows and so forth. Thus, the parameters 212-214 coupled to the inputs 71-73 of the UI definition 7 are outputted in a UI when the business application is running.

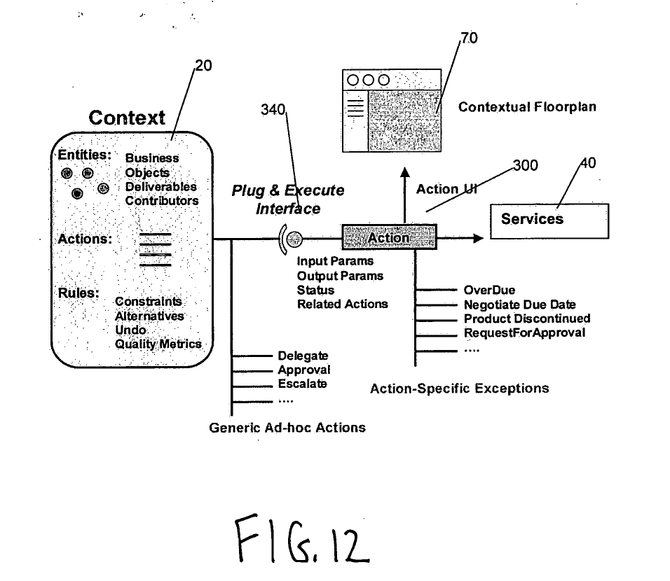

FIG. 10 shows an example of a system on which an implemented business application is running. The system is provided with an instantiated context 20. When the business application is run, the parameters of the model represented by the instantiated context 20 are given values, such that the model represents an actual situation in a business environment. In the instantiated context 64 shown in FIG. 6, the supplier is given a name of an actual supplier of components, the owner is given a value representing an employee of an enterprise etc.

The context is connected to a user-interface 70 vis link 210. Parameters of the context 20 have been mapped to the inputs of a UI definition during implementation of the business application. The GUI 70 conforms with the UI definition 7. Thus, when the implemented business application is running, parameters of the context 20 are coupled to the GUI 70 and parameters of the context 20 can be outputted visually in the GUI 70. Thereby, a user can perceive a current state of the context 20, for example, which persons are contributed in the specific context, which actions can be performed in the context, and so forth.

The contexts 20,21 are further connected to actions 300-302 via plug-and play interfaces 340, 341, 342. During implementation, parameters of the instantiated context are mapped to inputs and or outputs of action definitions. The actions 300-302 conform with these action definitions. Thus, for each respective action 300-302, contexts are immediately ready to receive or send data to the actions 300-302 when the business application is run.

In this example, as indicated with the dashed lines 310, 311 the actions can exchange data via the context 20. The context 20 is connected to more than one action in a manner as explained above with reference to FIG. 7. For example, the first action 300 can output data to the context 20, thus modifying the context 20. A second action 301 can use parameters from the modified context and receive data from the first action 300. Since the communication of data between the actions is lead via the context, the interfaces of the actions do not have to be matched to each other.

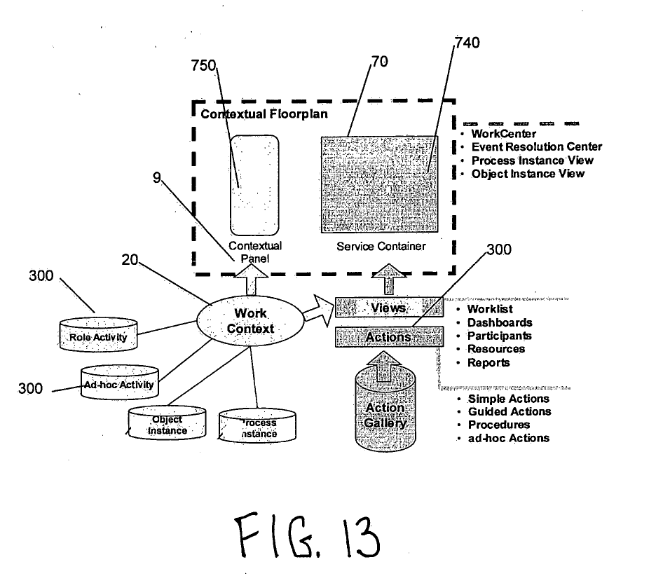

FIG. 11 is a block diagram of a Graphical User Interface (GUI) suitable for in the example of FIG. 9. The GUI has a context information window 700 in which information about the current context is displayed. The name of the current context is visually outputted. However, the context information window 700 may likewise contain other suitable information about the current context.

The GUI 70 has a control window provided with controls 710,711,720 and 730. An action control 710 allows a user of the system to view actions linked to the current context. For example, the action control 710 can provide the user with a sequence of actions used to perform successive steps in a business process related to the current context. Via a view control 711, a user can select a view of the current context. For example, by selecting the view control, a list of participant in the current context is outputted in the service window 740 or any other suitable parameter of the current context. An object/method control 720 allows a user to control or select objects or methods of the current context. A recent context control 720 visually outputs which contexts have been used recently, and allows a user to select one of the recently used contexts.

The context definitions include at least one of: types of participants, status data and actions associated with the business state. The context template may for example include one or more of the following: slots, inferred variables, actions, rules and contextual floorplans, as will be explained below in more detail. Slots are variables that are initialized upon instantiation of the context out of the business context.

Turning to FIG. 12 there is shown a diagram of an action and its connection to a specific work context. An action 300 is instantiated providing an interface 340 to a work context 20. The action 300 activates one or more generic services, preferably web services, wherein a predefined number of data objects are handled in the work context 20. An action may be viewed as a context aware service: it functions as a wrapping layer that executes the service while providing the service of the appropriate context data. The action 300 is preferably designed to have a plug & execute interface 340 which may be described as a generic data-interface through which data exchange is possible from the context to the action. In this way actions can be re-used as task building blocks in any context.

In particular, actions are atomic tasks or particular instances of work that a user performs in a given work context 20 or steps that users must execute in a process. Depending on the complexity of the Action, a user interface 340 is provided differently wherein Action patterns are provided by the user interface framework. In this manner, a user centric interface is provided where for a user, actions are perceived as a single task from within the current context. The detailed design of the user interface 70 is determined by the task that is executed. The general appearance is defined by a user interface generator.

Several Action types can be distinguished:

Simple Actions. Such Actions are supported by one single screen that can be launched within a context next to the Contextual Panel.

Guided Actions. Such Actions require a multiple screens sequence that models the task or interaction flow needed to perform this Action. A wizard like roadmap component guides the user through all steps.

Quick Actions. This Action type not launched in-place within an active context but rather when opening a pushed notification or work item. The Quick Action is a kind of interactive workflow message that provides an explanation of the trigger as well as the user interface required to respond to this work item.

In the user interface 70 a Contextual Action Bar may be provided which supports the display of response options provided by the work item. Those are typically workflow options like “yes”, “no”, “reject”, “reply”, “delegate”.

There are also other task management options provided such as “prioritize”, “add to My Lists”, “Open related work context”, transform into a procedure or ad-hoc Activity, and so forth.

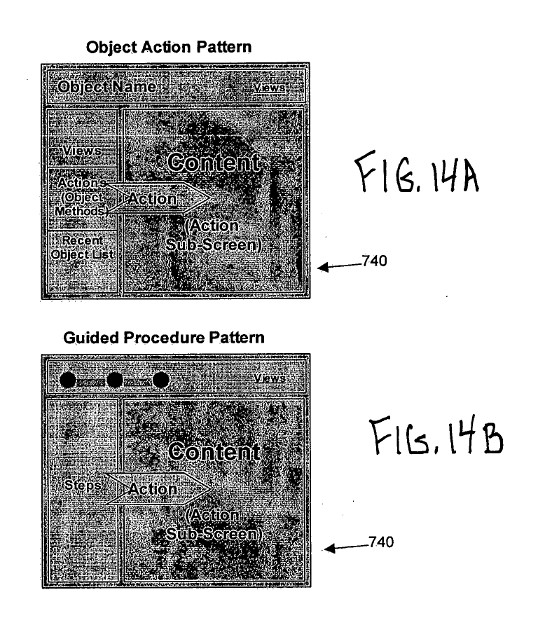

FIG. 13 is a specific layout for user interface 70 that provides an action interface as described above. This layout is called “Contextual Floorplans”. All screens that cover more than a single action are designed as a place to do work—they include many different functions and views all supporting one coherent activity. The general page layout for such places is called Contextual Floorplan and includes a left hand Contextual Panel for navigation, and a right hand container for launching services in-place. Those in-place actions enable the user to perform actions without leaving the current work context 20. Depending on the user focus the context may represent a role-specific activity or a specific work instance like a workflow or business object. In the contextual floorplan 70 a “contextual panel” 750 is present and a “service container” 740. The contextual panel 750 is designed to provide the most important functionality and navigation within the current working context. The Contextual Panel 750 typically offers a list of views or facets on the current work context 20 and a list of related actions.

The Contextual Panel 750 may provide view switches to select different facets of the current work context 20. They are basically a toolset to divide complex function into several intuitive chunks. The switches navigate between different views 9 of the same context. Each view, when activated, may replace subordinate content in the Context Panel 750, so that this panel is changed to show for example different related actions.

Although the same generic control and layout is used, the exact semantics vary depending on the type of work context 20.

Activity-centric Views: Views on this level represent generic perspectives on work. Such Views are focused on one particular work role. They also may represent secondary activity centers that require their own set of actions.

Object-centric Views: Facets on this level represent different views on a given business object. They entirely depend on the type of object and reflect natural perspectives on that object. Each perspective may come with its own set of actions and by that represents a little activity center with focus on one concrete business object instance. Reference is made to FIG. 14A.

Process Instance Views: On this level, facets are mainly generic process tracking and execution views provided by the Guided Procedure framework as will be explained further below. Those views can be extended by tailored views depending on the semantics of the procedure. Reference is made to FIG. 14B.

FIGS. 14A and 14B show example user interfaces which are dependent on a typical work context view. FIG. 14A shows an Object centric view, wherein a Service container 740 is presented to provide specific actions on business objects provided by the work context. FIG. 14B shows a process centric view, where an action is presented to perform a specific step in a typical guided procedure. Typically in a Guided Procedure project processes are modeled by integrating existing and newly implemented services into a coherent procedure. In this way the workflow as experienced by this user; whether the user is the owner of the process, or at least this part of it; the work objects managed by the process. Guided Procedures support collaboration amongst multiple users all working towards a common goal, each contributing their share. UI elements of the Guided Procedure allow for navigation through the process, indicate the status of the process, and provide different views on the process.

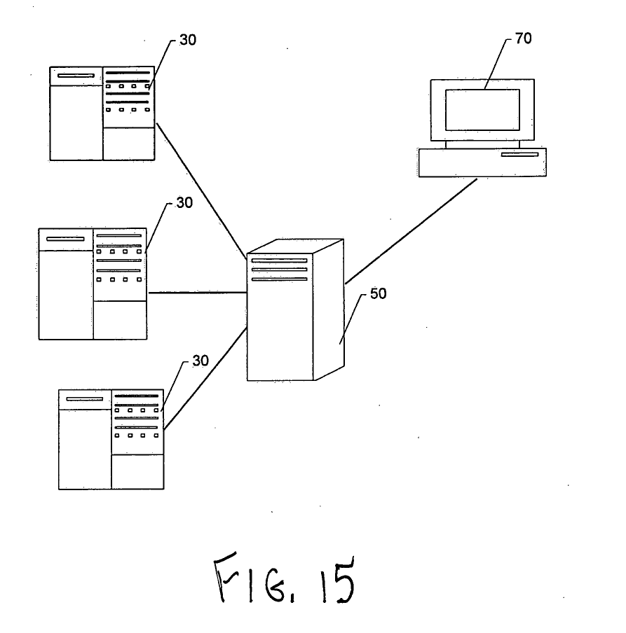

FIG. 15 an exemplary computer network suitable for running a business application shown. The computer network includes a number, in this example three, of server systems 30. Each of these server systems 30 is communicatively connected to a context server 50. On the server systems 30 a set of procedures or functions are hosted that provide an action to the context server 50. The context server 50 can request data from the computer server, by submitting a set of parameters to the set of procedures or functions on the server. On the server 50 two or more contexts are present, and the server 50 is arranged to submit parameters of a selected context to the actions provided by the server systems 30 or to receive data from the server systems and adjust the selected context in correspondence with the received data. The context service 50 is further connected to a computer system provided with a GUI 70 on which aspects of the selected context and/or the actions can be outputted visually, as explained with reference to FIG. 10.

The invention may also be embodied in a toolkit for implementing a business application. The toolkit may have a context repository in which at least two context templates are stored, each of the context templates defining actors in a work context.

The toolkit may further have an action repository in which at least two action templates are stored, which action templates define at least an input or output of a service. The toolkit may further have a context instantiation component for instantiating a context based on a context template stored in the context repository. The toolkit may further have an action association component for associating at least one action template with the instantiated context. The toolkit may further have a mapping component for mapping at least one parameter of the instantiated context with at least one input or output of the associated action templates, for using the parameter as input to the service or outputting data from the service to the parameter when the business application is running.

The invention may also be embodied in a computer system provided with a toolkit, the computer system comprising at least one memory in which the context repository and the action repository are stored, and at least one processor communicatively connected to the memory, the at least one processor including the context instantiation component, the action association component and the mapping component. A computer (system) includes any type of programmable apparatus such as a desktop computer, a personal digital assistant, a (mobile) telephone or any other suitable type of programmable device. A computer (system) may include one or more of such devices communicatively connected in a suitable manner. To provide for interaction with a user, a computer system can be used having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

The invention may also be embodied in a business application, including a computer program product with code portions representing at least one instantiated context based on a context template stored in a context repository; and representing at least one input/output interface for transferring data from the instantiated context to an associated service or vice versa, wherein at least one parameter of the instantiated context is connected to the input/output interface, for inputting the aspect to the service or outputting data from the service to the aspect when the business application is running on a computer.

It should be noted that the above-mentioned embodiments illustrate rather than limit the invention, and that those skilled in the art will be able to design alternatives without departing from the scope of the appended claims. For example, the computational aspects described here can be implemented in digital electronic circuitry, or in computer hardware, firmware, software, or in combinations of them. Where appropriate, aspects of these systems and techniques can be implemented in a computer program product tangibly embodied in a machine-readable storage device for execution by a programmable processor, and method steps can be performed by a programmable processor executing a program of instructions to perform functions by operating on input data and generating output.

Also, for example, the parameter and/or inputs and/or outputs of the contexts and action definitions described in FIGS. 6 and 7 may be mapped differently depending on the specific implementation.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
in a computer system including a context repository in which at least two context templates are stored, each of the context templates representing a meta-model of a business situation, and an action repository in which at least two actions are stored having respective action definitions, instantiating a context in response to the business situation based on a context template stored in the context repository, the instantiated context representing a model of the business situation;
associating at least one action with the instantiated context;
generating a user interface (UI) based on an interface template, the UI enabling at least one action to a user based on the instantiated context, the at least one action adopting the instantiated context;
in response to a user's selection of one of the at least one action, enabling the user with a plurality of sub-actions the user can perform before completing the one action; and
adding the plurality of sub-actions to the instantiated context, the sub-actions adopting the instantiated context.

2. The computer-implemented method of claim 1 further comprising filtering the instantiated context associated with the one or more action so the plurality of sub-actions added adopt the filtered instantiated context.

3. The computer-implemented method of claims 1 further comprising enabling a control in the UI to govern a completion of at least one of the action and sub-action.

4. The computer-implemented method of claim 1 wherein the plurality of actions and sub-actions are portable user interface (UI) services.

5. The computer-implemented method of claim 1 wherein the actions are related goals and the sub-actions are related sub-task.

6. The computer-implemented method of claim 5 wherein the sub-tasks are contextual actions that the user can perform before completing a goal.

7. The computer-implemented method of claim 1 wherein the instantiated context comprises context data, the context data being passed to the sub-actions.

8. The computer-implement method of claim 1 wherein the generated UI enables a stacking the sub-actions on the selected action.

9. The computer-implemented method of claim 8 further comprising a user interface navigation framework (UINF) for that maintains context through the stack of sub-actions.

10. The computer-implemented method of claim 1 further comprising incrementally adding additional context with each sub-task.

11. The computer-implemented method of claim 1 wherein a sub-action is provided as a possible action that the user should complete before successfully completing an action.

12. Apparatus for contextual navigation and action stacking in a business application, the apparatus comprising digital circuitry configured to perform the following actions:
in a computer system including a context repository in which at least two context templates are stored, each of the context templates representing a meta-model of a business situation, and an action repository in which at least two actions are stored having respective action definitions, instantiate a context in response to the business situation based on a context template stored in the context repository, the instantiated context representing a model of the business situation;
associate at least one action with the instantiated context;
generate a user interface (UI) based on an interface template, the UI enabling at least one action to a user based on the instantiated context, the at least one action adopting the instantiated context;
in response to a user's selection of one of the at least one action, enable the user with a plurality of sub-actions the user can perform before completing the one action; and
add the plurality of sub-actions to the instantiated context, the sub-actions adopting the instantiated context.

13. The apparatus of claim 12, wherein the apparatus comprises a programmable processor and the apparatus is configured by instructions stored in a memory for execution by the processor.
